(19) United States
(12) Patent Application Publication
(10) Pub. No.: US 2013/0060473 A1
(43) Pub. Date: Mar. 7, 2013

(54) INFORMATION TERMINAL DEVICE, GROWTH MANAGEMENT SYSTEM AND COMPUTER-READABLE MEDIUM

(71) Applicant: Takahiro Tomida, Tokyo (JP)

(72) Inventor: Takahiro Tomida, Tokyo (JP)

(73) Assignee: CASIO COMPUTER CO., LTD., Tokyo (JP)

(21) Appl. No.: 13/593,657

(22) Filed: Aug. 24, 2012

(30) Foreign Application Priority Data
Sep. 5, 2011 (JP) 2011-192696

(51) Int. Cl. G01W 1/00; G06F 19/00

(52) U.S. Cl. 702/3

(57) ABSTRACT

In the present invention, a mobile phone judges whether the current environment of a plant is equivalent to a specific season for the plant, based on a detected environment received and acquired from a sensor device including an environment sensor (temperature sensor, moisture sensor, etc.) for detecting a growth environment and the season-specific growth basic information of the plant received and acquired from a server device, and then specifies growth information (growth advice) applicable to the judged season as an output subject.

### CROSS-REFERENCE TO RELATED APPLICATION

This application is based upon and claims the benefit of priority from the prior Japanese Patent Application No. 2011-192696, filed Sep. 5, 2011, the entire contents of which is incorporated herein by reference.

### BACKGROUND OF THE INVENTION

1. Field of the Invention

The present invention relates to an information terminal device, a growth management system and a computer-readable medium where growth information regarding a growth subject is outputted based on a correlation between a type of the growth subject and a season.

2. Description of the Related Art

Generally, in the growth and cultivation of plants, the amount of water to be given to a plant, the way it is exposed to sunlight or fertilized, temperature conditions, and the like vary depending on the type of the plant and its growth environment. Accordingly, there are conventional technologies for providing a user with information related to the growth of plants. For example, there is a technology (plant raising guide system) in which the growth environment of a plant is observed (detected) by a sensor, the detected growth environment (detected environment) is stored, managed, and compared with an optimal growth environment for the plant, and guiding display related to the plant growth is performed based thereon (refer to Japanese Patent Application Laid-Open (Kokai) Publication No. 2010-075172). Also, there is a technology in which optimal conditions for plant growth are calculated and outputted based on an environment detected by an environment sensor and plant growth information registered in a server device (refer to Japanese Patent Application Laid-Open (Kokai) Publication No. 2003-310054).

The technologies described in Japanese Patent Application Laid-Open (Kokai) Publication Nos. 2010-075172 and 2003-310054 assist in the growth of plants. However, the method of growing a plant varies depending on the type of the plant, the season and the environment, and therefore plants cannot always be suitably managed according to seasonal and environmental changes.

Even if plants are managed using a growth method suitable to a season for each type of plant, they do not successfully grow in many cases. One of the reasons for the failure is watering.

For example, during the cold winter months, plants should not be watered in some cases even when the soil is dry. However, if the plants are house plants being grown indoors where the temperature is warm, they should be watered even in the same winter months. Also, during the hot summer months, plants should be watered frequently. However, if the plants are house plants being grown indoors where the temperature is cool, they should not be frequently watered even in the same summer months.

In such instances, if the plants are uniformly managed using a growth method in accordance with the calendar-based seasons, the plants may die of excessive or insufficient watering. This is not limited to watering, and similarly applies to the way plants are exposed to sunlight or fertilized, and the like. In addition, this is not limited to indoor cultivation, and similarly applies to outdoor cultivation. For example, when the growth environment of plants is radically changed by abnormal weather, the same problem occurs.

### SUMMARY OF THE INVENTION

An object of the present invention is to enable growth information to be changed according to the growth environment of a plant irrespective of calendar-based seasons, when that growth information is outputted based on a correlation between the type of the growth subject and a season.

In order to achieve the above-described object, in accordance with one aspect of the present invention, there is provided an information terminal device comprising: a receiving section which receives a detected environment detected from a sensor device equipped with an environment sensor that detects a growth environment of a growth subject with the environment sensor; an acquisition section which acquires season-specific growth basic information according to a type of the growth subject, when the detected environment is received; a judgment section which judges whether the current environment of the growth subject is equivalent to a season specifically for the growth subject, based on the detected environment and the season-specific growth basic information; a specification section which specifies growth information applicable to the season as an output object; and an output control section which outputs information representing the season that corresponds with the growth information to an output section, when the growth information is specified as an output object.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A to FIG. 1C are diagrams showing a communication system (growth management system) that can be used by a mobile phone to which the present invention has been applied as an information terminal device;

FIG. 2 is a schematic vertical cross-sectional view for describing the structure of a sensor device 2;

FIG. 3 is a block diagram showing basic components of a mobile phone 1;

FIG. 4 is a diagram for describing the contents of a plant growth database 6;

FIG. 5 is a diagram for describing season judgment rules used for determining a season;

FIG. 6 is a flowchart outlining operations of the characteristic portion of a first embodiment from among all of the operations of the mobile phone 1;

FIG. 7 is a flowchart for describing in detail growth advice generation processing (Step A8 in FIG. 6);

FIG. 8 is a flowchart of operations following the operations in FIG. 7;

FIG. 9A is a diagram showing an example of character display in which growth information (growth advice) has not been added, and FIG. 9B and FIG. 9C are diagrams showing examples of character display in which growth information has been added;

FIG. 10 is a block diagram showing basic components of a server device 5 according to a second embodiment;

FIG. 11 is a flowchart outlining operations of the characteristic portion of the second embodiment from among all of the operations of the mobile phone 1; and

FIG. 12 is a flowchart outlining operations performed on the server device 5 side in the second embodiment.

### DETAILED DESCRIPTION OF THE PREFERRED EMBODIMENTS

The preferred embodiments of the present invention will hereinafter be described with reference to the drawings.

### First Embodiment

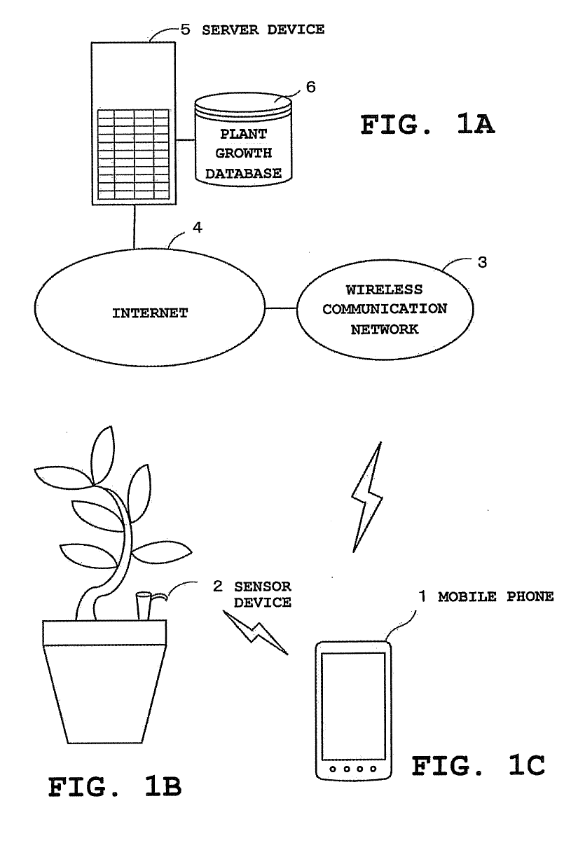

First, a first embodiment of the present invention will be described with reference to FIG. 1A to FIG. 9.

The first embodiment is an example in which the present invention has been applied to a mobile phone as an information terminal device, and FIG. 1A to FIG. 1C are diagrams showing a communication system (growth management system) that can be used by this mobile phone.

The growth management system is configured to include an information terminal device (mobile phone) 1 that outputs growth information (growth advice) regarding a growth subject (such as a plant) based on a correlation between a type of the growth subject and a season, a sensor device 2 that detects the growth environment of a plant, a wireless communication network 3, the Internet 4, and a management device (server device) 5 that manages season-specific growth basic information according to the type of plant.

In the first embodiment, although details will be described later, the “growth environment of a plant” refers to ambient temperature around a plant and the moisture content of soil near the plant detected by an environment sensor, and the “season-specific growth basic information” includes information indicating conditions for season judgments which are determined based on the heat-hardiness temperature and the cold-hardiness temperature of a plant, and information indicating conditions for generating growth advice for each season. The mobile phone 1 judges whether the current growth environment of a plant is equivalent to a specific season for the plant, based on the growth environment (detected environment) of the plant received and acquired from the sensor device 2, which is equipped with an environment sensor (temperature sensor, moisture sensor, etc.) that detects the growth environment of a plant, and the season-specific growth basic information of the plant received and acquired from the server device 5. Subsequently, the growth information (growth advice) applicable to that judged season is specified as an output object, and the growth information is displayed on the terminal screen.

A call function, an electronic mail function, an Internet connection function (web access function), a short-range communication function, etc. are provided by this mobile phone 1. When the mobile phone 1 is connected to the wireless communication network 3 via a nearby base station (not shown), phone calls and electronic mail transmissions can be made between the mobile phone 1 and another mobile phone (not shown) over the wireless communication network 3. Also, when the mobile phone 1 is connected to the Internet 4 via the wireless communication network 3, electronic mail transmissions can be made and web pages can be viewed. This mobile phone 1 periodically accesses the sensor device 2 set near a plant (such as within a flower pot) everyday (such as at 7 am or 6 pm daily) using short-range communication (the communication distance is, for example, 10 meters), and requests it to transmit data. Note that the request for data transmission from the mobile phone 1 side to the sensor device 2 is not necessarily required to be made at 7 am or 6 pm every day, and the frequency and timing of the request can be arbitrarily and freely set by user operation.

The sensor device 2 measures (detects) the growth environment of a plant periodically, such as every hour or five times during the daytime, and sequentially stores measured growth environments. In a case where this detection is performed five times a day, for example, the sensor device 2 detects the growth environment of the plant every two hours between 9 am to 5 pm, and sequentially stores detected growth environments. Then, in response to a request for data transmission from the mobile phone 1, the sensor device 1 transmits the stored detection results to the mobile phone 1 that has issued the request, as the growth environments of the plant up to this point. When transmitting them, the sensor device 1 also transmits the plant name. Note that the detection performed on the sensor device 2 side is not necessarily required to be performed every two hours between 9 am and 5 pm, and the frequency and timing of the detection can be arbitrarily and freely set by user operation.

When the mobile phone 1 receives and acquires the growth environments (detected environments) of the plant and the plant name from the sensor device 2, it requests the server device 5 to transmit the season-specific growth basic information of the plant, via the wireless communication network 3 and the Internet 4. Then, in response to the transmission request from the mobile phone 1, the server device 5 accesses a plant growth database 6 that stores season-specific growth basic information in accordance with the type of plant, and after reading out the season-specific growth basic information of the plant being requested, transmits the season-specific growth basic information to the mobile phone 1 that has issued the request. Subsequently, based on the growth environments (detected environments) of the plant received from the sensor device 2 and the season-specific growth basic information received from the server device 5, the mobile phone 1 judges whether the current environment of the plant is equivalent to a specific season for the plant, irrespective of the calendar-based season, and specifies growth information (such as advice information recommending watering) relevant to the determined season as an output object. The mobile phone 1 then displays the specified growth information on the terminal screen. When displaying information applicable to a specific season, the mobile phone 1 displays on the terminal screen, for example, a drawing expressing a sense of the season image and the season name.

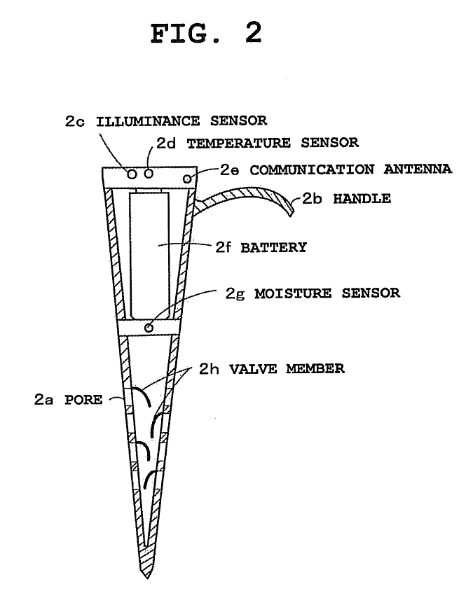

FIG. 2 is a schematic vertical cross-sectional view for describing the structure of the sensor device 2.

The sensor device 2 is a compact electronic device with a communication function which includes an environment sensor for observing the growth environment of plants, such as potted plants or flowers, and the housing as a whole is in the shape of an elongated hollow stick. This hollow stick-shaped body of the sensor device 2 is formed into a tapered shape, and the lower portion (such as the bottom half) thereof is inserted into the soil of a plant pot or the like. On the surface of the sensor device 2 on the lower portion side, a plurality of pores 2a for air ventilation and water conduction are formed. Also, on one side of the upper end portion of the sensor device 2, an arc-shaped handle 2b is formed (integrally formed) projecting outward. When inserting the lower portion of the sensor device 2 into the soil of a planter or removing it therefrom, the user hooks his or her index finger around the lower side of the handle 2b while pressing the upper end surface of the sensor device 2 by the pad of their thumb. As a result, the sensor device 2 can be smoothly inserted or removed.

In the top plate portion of the sensor device 2 on the upper end side, various electronic components, such as an illuminance (sunlight) sensor 2c that detects brightness around a plant, an ambient temperature sensor 2d that detects air temperature around a plant, a short-range communication section antenna 2e, a control section that controls the operations of these components, and a storage section (not shown) that sequentially stores detection results from these sensors, are included, and a power supply battery 2f is mounted below this top plate portion. In addition, in the center partition portion of the sensor device 2, a moisture sensor 2g that detects the moisture content of soil (soil humidity) is included. Moreover, in the hollow portion of the sensor device 2, a plurality of valve members 2h for preventing infiltration of soil are formed in areas where the pores 2a are formed.

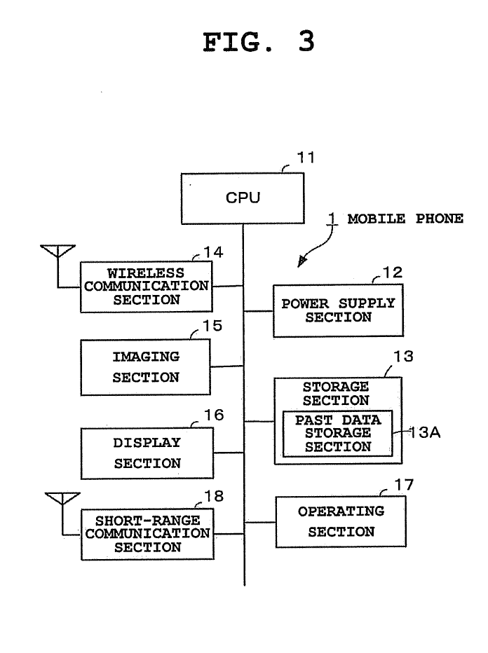

FIG. 3 is a block diagram showing basic components of the mobile phone 1.

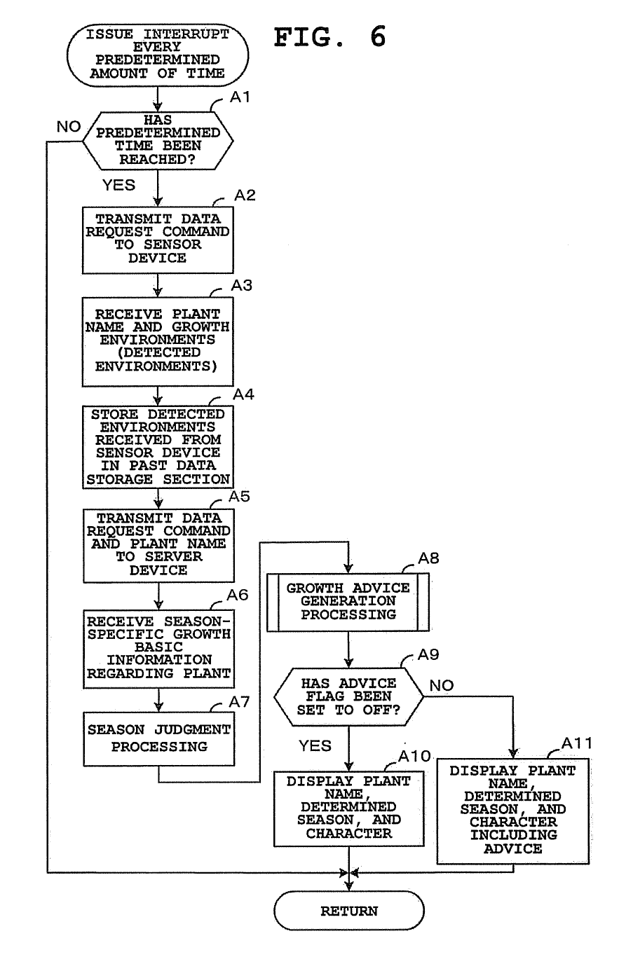

A central processing unit (CPU) 11 shown therein is a section that operates by receiving power from a power supply section 12 including a secondary battery (not shown), and controls the overall operation of the mobile phone 1 based on various programs stored in a storage section 13. The storage section 13 stores programs for actualizing the first embodiment based on operation procedures shown in FIG. 6 to FIG. 8, various applications, and the like, and is provided with a work area that temporarily stores various information required to operate the mobile phone 1. A past data storage section 13A is a work area that temporarily stores the growth environments (detected environments) of a plant received from the sensor device 2 side, which is capable of storing data amounting to at least M hours (for example, M=72 hours) described later.

A wireless communication section 14 is a wide-range communication section used for the call function, the electronic mail function, and the Internet connection function. An imaging section 15 constitutes a camera section capable of capturing a subject in high-definition, which includes an optical lens, an image sensor, an optical drive section, a flash for lighting, an analog processing circuit, a signal processing circuit, and the like (not shown). A display section 16 includes, for example, a high-definition liquid crystal display, an organic electroluminescent (EL) display, or an electrophoretic display (electronic paper), and displays display information, such as text information and a wallpaper image. When the camera function is in use, the display section 16 serves as a finder screen, and displays a live-view image (monitor image) as a capturing image. On the surface of the display section 16, a touch screen is provided by a contact operating section (transparent contact sensor) that detects finger contact being layered over the surface.

An operating section 17 has, for example, a power ON/OFF button and a button that switches the mode of the mobile phone 1 to a camera monitor mode (not shown), and the CPU 11 performs processing corresponding to these operating buttons. A short-range communication section 18 constitutes a Bluetooth (registered trademark) module and performs communication with the sensor device 2. The communicable area is, for example, within a range of 10 meters. However, the communicable range is not limited thereto. When the mobile phone 1 transmits a search signal to find the sensor device 2, and the sensor device 2 responds to the search signal, a communication link between the mobile phone 1 and the sensor device 2 is established, and data communication can be performed therebetween.

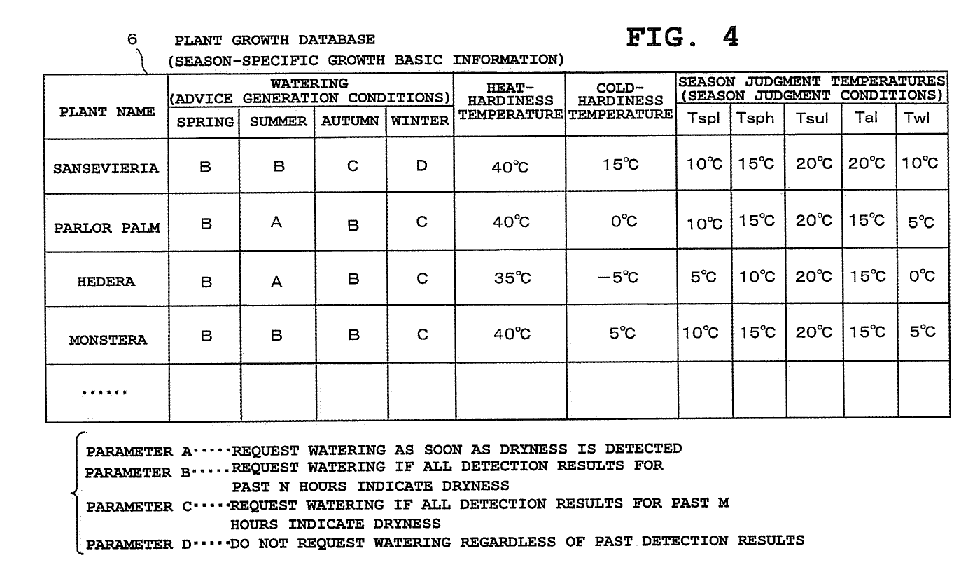

FIG. 4 is a diagram for describing the contents of the plant growth database 6.

The plant growth database 6 stores season-specific growth basic information in accordance with the type of plant. This season-specific growth basic information includes information indicating conditions for seasonal judgments which are determined based on the cold-hardiness temperature and the heat-hardiness temperature of a plant, and information indicating conditions for generating growth advice for each season. In the plant growth database 6, a “plant name” field, a “watering” field, a “heat-hardiness temperature” field, a “cold-hardiness temperature” field, and a “season judgment temperatures” field are included. The “plant name” field indicates the type of plant that is the growth subject. In the example shown in FIG. 4, “sansevieria”, “parlor palm”, etc. have been stored. The “watering” field indicates conditions for generating growth advice that recommends watering based on a season, and stores condition parameters A, B, C, and D for determining whether or not to request the user to water a plant (generates growth advice) based on the type of the plant, the season and the soil dryness of the plant being grown. In the example shown in FIG. 4, condition parameter B has been stored corresponding to “spring” and “summer”, condition parameter C has been stored corresponding to “autumn”, and condition parameter D has been stored corresponding to “winter” for a case where “plant name” is “sansevieria”.

Condition parameter A indicates that the mobile phone 1 “requests watering as soon as soil becomes dry”, condition parameter B indicates that the mobile phone 1 “requests watering when all sensor detection results (detected environments) for the past N hours indicate dryness”, condition parameter C indicates that the mobile phone 1 “requests watering when all sensor detection results (detected environments) for the past M hours indicate dryness”, and condition parameter D indicates that the mobile phone 1 “does not request watering regardless of past sensor detection results (detected environments)”, as shown in FIG. 4. The above-described “N” and “M” have a relationship “N<M”. For example, N=24 hours and M=72 hours. The values of “N” and “M” can be set arbitrarily by user operation. The “heat-hardiness temperature” field and the “cold-hardiness temperature” field indicate the temperature-related characteristics of a corresponding plant. In the example shown in FIG. 4, when “plant name” is “sansevieria”, “heat-hardiness temperature” is “40° C.” indicating high tolerance to heat, and “cold-hardiness temperature” is “15° C.” indicating low tolerance to cold.

The “season judgment temperatures” field is used to judge whether the current environment of a plant is equivalent to a specific season for the plant, irrespective of the calendar-based season. The season judgment temperatures are seasonal judgment conditions determined based on the heat-hardiness temperatures and the cold-hardiness temperatures of plants, and a different value is stored for each type of plant. Generally, in an environment where the temperature is high and plants grow vigorously, watering frequency may be high. However, in an environment where the temperature is low and plants are resting, watering is withheld. For example, “sansevieria” has low tolerance to cold and therefore watering should be withheld during periods where the daytime temperature is 15° C. or lower. On the other hand, “hedra” has high tolerance to cold and therefore watering is not required to be withheld until a period where the temperature falls to subzero comes. Because of this difference, a different value is stored for each type of plant, as described above.

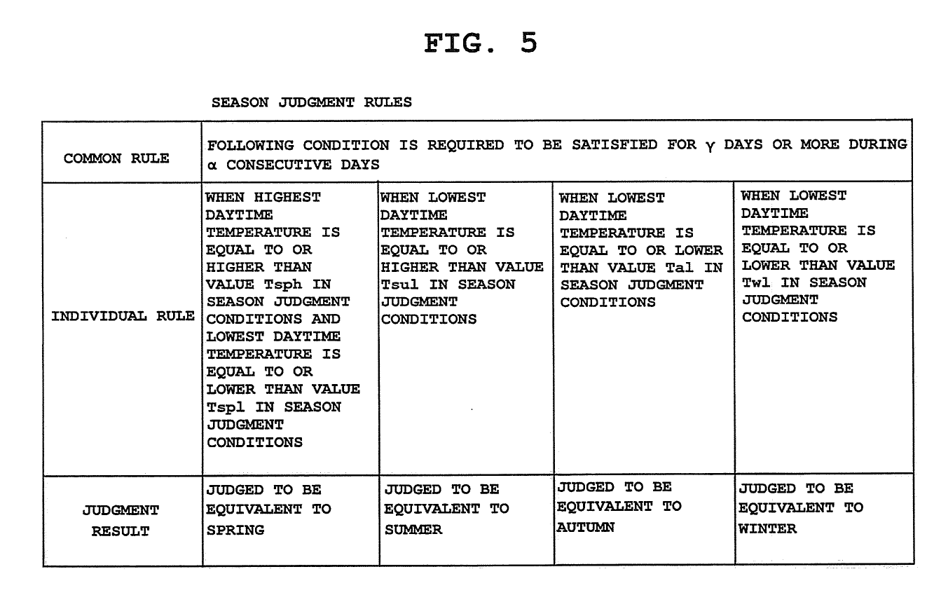

Here, the “season judgment temperatures” field has a “Tspl” field, a “Tsph” field, a “Tsul” field, a “Tal” field, and a “Twl” field. The “Tspl” field indicates the lowest daytime temperature in spring, the “Tsph” field indicates the highest daytime temperature in spring, the “Tsul” field indicates the lowest daytime temperature in summer, the “Tal” field indicates the lowest daytime temperature in autumn, and the “Twl” field indicates the lowest daytime temperature in winter. In the example in FIG. 4, “10° C.” has been stored in the “Tspl” field, “15° C.” has been stored in the “Tsph” field, “20° C.” has been stored in the “Tsul” field, “20° C.” has been stored in the “Tal” field, and “10° C.” has been stored in the “Twl” field for “sansevieria” that has low tolerance to cold. The mobile phone 1 performs a season judgment according to the season judgment rules in FIG. 5, based on the growth environments (detected environments) of a plant received from the sensor device 2 and “season judgment temperatures” for the plant.

FIG. 5 is a diagram for describing the season judgment rules used for seasonal judgments.

The season judgment rules include a “common rule” and an “individual rule”. The “common rule” prescribes that “following condition (individual rule) is required to be satisfied for γ days or more during α consecutive days”, and the “individual rule” prescribes four rules corresponding to spring, summer, autumn, and winter. That is, the “individual rule” states “a case where the highest daytime temperature is equal to or higher than the value Tsph of season-specific growth basic information (season judgment temperatures) and the lowest daytime temperature is equal to or lower than the value Tspl of the season-specific growth basic information (season judgment temperatures)” as a first rule.

Also, the “individual rule” states “a case where the lowest daytime temperature is equal to or higher than the value Tsul of season-specific growth basic information (season judgment temperatures)” as a second rule, “a case where the lowest daytime temperature is equal to or lower than the value Tal of season-specific growth basic information (season judgment temperatures)” as a third rule, and “a case where the lowest daytime temperature is equal to or higher than the value Twl of season-specific growth basic information (season judgment temperatures)” as a fourth rule. When the first rule is satisfied, “the current environment of a plant is judged to be equivalent to spring”. When the second rule is satisfied, “the current environment of a plant is judged to be equivalent to summer”. When the third rule is satisfied, “the current environment of a plant is judged to be equivalent to autumn”. When the fourth rule is satisfied, “the current environment of a plant is judged to be equivalent to winter”.

Next, the operational concept of the mobile phone 1 according to the first embodiment will be described with reference to the flowcharts shown in FIG. 6 to FIG. 8. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later.

FIG. 6 is a flowchart outlining operations of the characteristic portion of the first embodiment from among all of the operations of the mobile phone 1, which are started by an interrupt that is issued every predetermined amount of time (such as one minute). Note that, after exiting the flow in FIG. 6, the procedure returns to the main flow (not shown) of the overall operation.

First, the CPU 11 judges whether or not a predetermined time (such as 8 am) set in advance has been reached, or in other words, whether or not request timing for issuing a request to the sensor device 2 has been reached (Step A1). When judged that the request timing has not yet been reached (NO at Step A1), the CPU 11 exits the flow in FIG. 6. When judged that the request timing has been reached (YES at Step A1), the CPU 11 transmits a request command requesting data transmission and its own terminal identification (ID) to the sensor device 2 (Step A2).

On the sensor device 2 side, the growth environment of the plant is measured (detected) periodically, such as every hour or five times during the daytime, and the detection results are sequentially stored. Then, when the request command for data transmission is received from the mobile phone 1, the sensor device 2 transmits the stored detection results to the mobile phone 1 that has issued the request, as the growth environment of the plant up to this point, and also transmits the plant name. When the mobile phone 1 receives the growth environments (detected environments) of the plant from the sensor device 2 side (Step A3), the mobile phone 1 adds and stores the received plant name and the detected environments in the past data storage section 13A (Step A4), and transmits a request command for data transmission and the plant name received from the sensor device 2 to the server device 5 (Step A5). When the request command for data transmission and the plant name are received from the mobile phone 1, the server device 5 side searches the plant growth database 6 based on the plant name, and after reading out season-specific growth basic information relevant to the plant name, transmits it to the mobile phone 1 that has issued the request. When the season-specific growth basic information is received from the server device 5 (Step A6), the mobile phone 1 proceeds to season judgment processing (Step A7). In the season judgment processing, the mobile phone 1 performs a season judgment with reference to “season judgment temperatures” in the season-specific growth basic information received from the server device 5 which are seasonal judgment conditions determined based on the cold-hardiness temperature and the heat-hardiness temperature of the plant, and the temperatures detected by the ambient temperature sensor 2d which are included in the growth environments (detected environments) of the plant received from the sensor device 2 side. When performing a season judgment, the mobile phone 1 performs the judgment based on the season judgment rules (common rule and individual rules) shown in FIG. 5.

Specifically, the mobile phone 1 first determines the highest daytime temperature and the lowest daytime temperature from, for example, environments measured (detected) every two hours during the daytime between 9 am and 5 pm, among the detected environments of the plant received from the sensor device 2 side. Then, the mobile phone 1 performs a seasonal judgment based on a rule where the highest temperature and the lowest temperature correspond from among the season judgment rules. For example, in a case where the plant name is “parlor palm” and the lowest daytime temperature is 20° C. or higher for γ days or more during α consecutive days, the current environment of the plant is judged to be equivalent to summer even when the calendar-based season is autumn. If the lowest temperature is 5° C. or lower for γ days or more in this case, the current environment of the plant is judged to be equivalent to winter. When the season is determined as described above based on the growth environment of the plant, the mobile phone 1 proceeds to growth advice generation processing (Step A8).

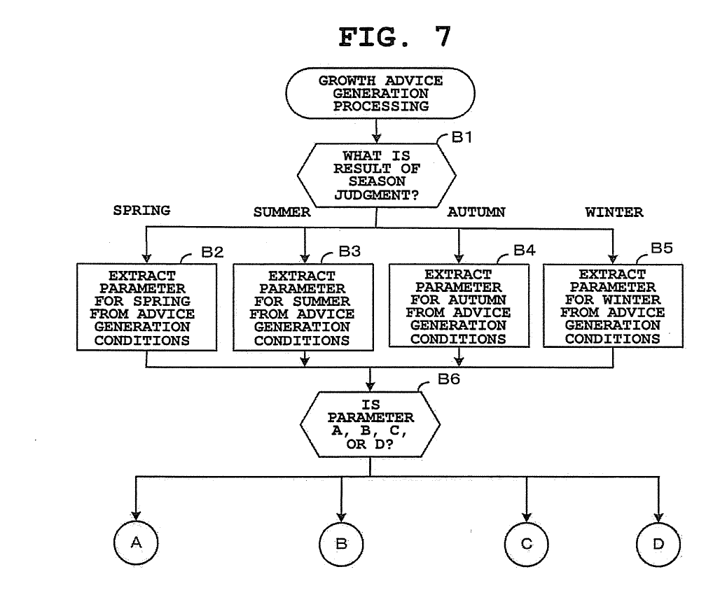

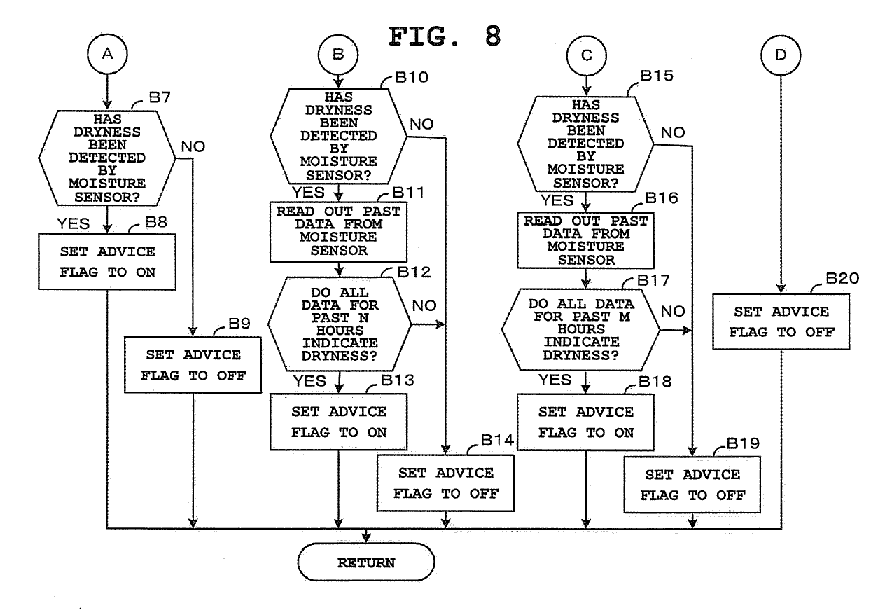

FIG. 7 and FIG. 8 are flowcharts for describing in detail the growth advice generation processing (Step A8 in FIG. 6).

First, the mobile phone 1 confirms the result of the season judgment made at Step A7 in FIG. 6 (Step B1). Next, based on the season judgment result, the mobile phone 1 extracts the corresponding condition parameter from the “watering” field which is included in the season-specific growth basic information received from the server device 5 and indicates conditions for generating growth advice for each season (Step B2 to Step B5). Specifically, when the judgment result of the season is spring, the mobile phone 1 extracts the condition parameter for spring (Step B2). When the judgment result of the season is summer, the mobile phone 1 extracts the condition parameter for summer (Step B3). When the judgment result of the season is autumn, the mobile phone 1 extracts the condition parameter for autumn (Step B4). When the judgment result of the season is winter, the mobile phone 1 extracts the condition parameter for winter (Step B5).

Then, the mobile phone 1 judges whether the extracted condition parameter is A, B, C, or D (Step B6), and proceeds to processing corresponding to this condition parameter in FIG. 8. In this instance, the mobile phone 1 checks the soil dryness of the soil with reference to results of detection by the moisture sensor 2g which are included in the growth environments (detected environments) received from the sensor device 2 side, and generates growth (watering) advice in accordance with the soil dryness. Specifically, when the condition parameter is judged to be A, the mobile phone 1 proceeds to Step B7 and judges whether or not soil dryness has been detected in any of detection results acquired by the moisture sensor 2g measuring (detecting) the moisture content of the soil periodically, such as every two hours during the daytime between 9 am and 5 pm, on the sensor device 2 side. When judged that soil dryness has been detected in one of the detection results (YES at Step B7), the mobile phone 1 sets an advice flag (not shown) indicating that watering advice should be given to “ON” (Step B8). Conversely, when judged that soil dryness has not been detected in any of the detection results (NO at Step B7), the mobile phone 1 sets the advice flag to “OFF” to indicate that watering advice is not generated (Step B9).

Also, when the condition parameter is judged to be B, the mobile phone 1 proceeds to Step B10 and judges whether or not soil dryness has been detected in any of the results of the detection by the moisture sensor 2g. When judged that soil dryness has not been detected in any of the detection results (NO at Step B10), the mobile phone 1 sets the advice flag to “OFF” (Step B14). When judged that soil dryness has been detected in one of the detection results (YES at Step B10), the mobile phone 1 reads out the detection results from the past data storage section 13A (Step S11) and judges whether or not all detection results for the past N hours (such as 24 hours) indicate soil dryness (Step B12). When judged that soil dryness has been occurring for N hours or more (YES at Step B12), the mobile phone 1 turns the advice flag to “ON” (Step B13). Conversely, when judged that soil dryness has been occurring for less than N hours (NO at Step B12), the mobile phone 1 sets the advice flag to “OFF” (Step B14).

Similarly, when the condition parameter is judged to be C, the mobile phone 1 proceeds to Step B15 and judges whether or not soil dryness has been detected in any of the results of the detection by the moisture sensor 2g. When judged that soil dryness has not been detected in any of the detection results (NO at Step B15), the mobile phone 1 sets the advice flag to “OFF” (Step B19). When judged that soil dryness has been detected in one of the detection results (YES at Step B15), the mobile phone 1 reads out the detection results from the past data storage section 13A (Step B16) and judges whether or not all detection results for the past M hours (such as 72 hours) indicate soil dryness (Step B17). When judged that soil dryness has been occurring for M hours or more (YES at Step B17), the mobile phone 1 turns the advice flag to “ON” (Step B18). Conversely, when judged that soil dryness has been occurring for less than M hours (NO at Step B17), the mobile phone 1 sets the advice flag to “OFF” (Step B19).

When the condition parameter is judged to be D, the mobile phone 1 proceeds to Step B20 and sets the advice flag to “OFF” regardless of the detection results from the moisture sensor 2g.

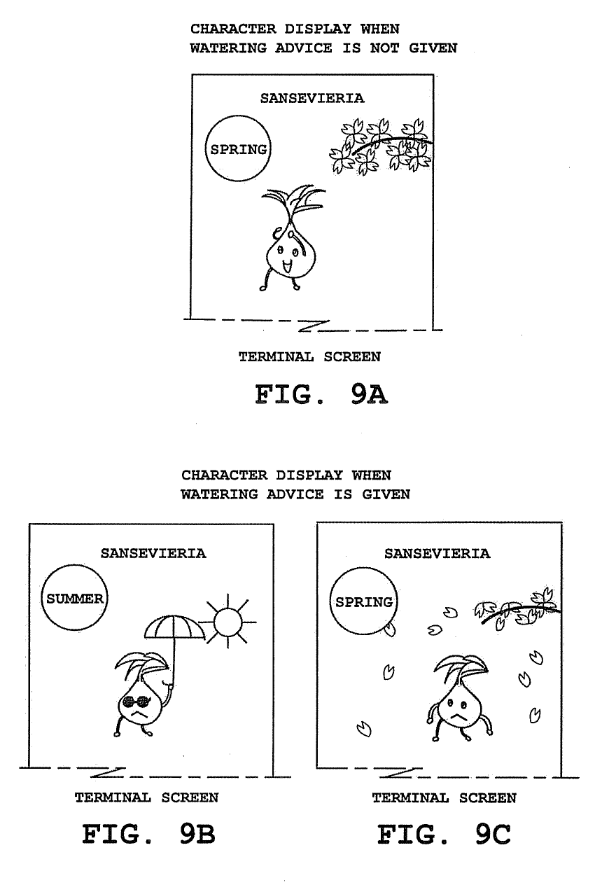

When the growth advice generation processing (Step A8 in FIG. 6) is completed as described above, the mobile phone 1 judges whether or not the advice flag has been set to “OFF” (Step A9). When judged that the advice flag has been set to “OFF” (Yes at Step A9), the mobile phone 1 displays the plant name, the determined season, and a predetermined drawing (character) representing the plant on the display section 16 (terminal screen) as display where growth advice has not been added (Step A10). FIG. 9A is an example of character display when growth information (growth advice) is not added, in which the plant name is “sansevieria” and the determined season is “spring”. The determined season is expressed by text and a seasonal drawing (cherry blossoms).

At Step A9, when judged that the advice flag has been set to “ON” (NO at Step A9), the mobile phone 1 displays the plant name, the determined season, and an advice-included character on the display section 16 (terminal screen) as display where growth advice has been added (Step A11). FIG. 9B and FIG. 9C are examples of character display when growth advice is added. In FIG. 9B, the plant name is “sansevieria” and the determined season is “summer”. Based on the current growth environment (insufficient moisture and soil dryness) of the plant, the character has been altered into a wilted state, and another drawing (parasol) has been added thereto. The determined season is expressed by text and a seasonal drawing (sun). In FIG. 9C, the plant name is “sansevieria” and the determined season is “spring”. Based on the current growth environment (insufficient moisture and soil dryness) of the plant, the character has been altered into a wilted state, and growth abnormality has been indicated by the falling petals of cherry blossoms in full bloom. The determined season is expressed by text and a seasonal drawing (cherry blossoms).

As described above, the mobile phone 1 of the first embodiment judges whether the current environment of a plant is equivalent to a specific season for the plant, based on detected environments received and acquired from the sensor device 2 including the environment sensor (temperature sensor, moisture sensor, etc.) for detecting growth environments, and the season-specific growth basic information of the plant received and acquired from the server device 5, and specifies growth information (growth advice) relevant to the determined season as an output object. Therefore, when outputting growth information for a plant based on a correlation between the type of the plant and a season, the growth information can be changed according to the growth environment of the plant, irrespective of the calendar-based season. Accordingly, the present invention is practically useful in that, even when plants are being grown indoors, plant growing that is suitable to the indoor environment is possible, and as a result the plants are adequately grown while being protected from abnormal weather or the like.

In addition, when the mobile phone 1 specifies growth information applicable to a season as an output object, information representing the season in association with the growth information is outputted. Therefore, in the present invention, the user can know which season is equivalent to the current growth environment of a plant.

Moreover, the mobile phone 1 displays a drawing (such as a character) expressing a growth method as growth advice and a drawing showing a sense of the season image as information expressing a season. Therefore, a display that is visually easy to understand and has many variations is possible.

Furthermore, the mobile phone 1 receives a plurality of detected environments related to air temperature as time-series changes in air temperature from the sensor device 2 that sequentially stores a plurality of environments periodically detected by the temperature sensor 2d that detects air temperature around a plant, and after determining the lowest temperature or the highest temperature from the received time-series changes in air temperature, judges whether the current environment of the plant is equivalent to a specific season for the plant, based on the lowest or the highest temperature and the season-specific growth basic information of the plant related to air temperature which has been received and acquired from the server device 5. Therefore, a season can be determined by air temperature rather than a calendar. Accordingly, even when plants are being grown indoors, plant growing that is suitable to an indoor environment is possible.

Still further, the mobile phone 1 receives a plurality of detected environments as soil dryness conditions in time-series from the sensor device 2 that sequentially stores a plurality of environments related to moisture periodically detected by the moisture sensor 2g that detects the soil dryness conditions of a plant being grown, and specifies information related to watering that corresponds to growth information as an output object, based on the received soil dryness in time-series. As a result, whether or not to water a plant can be determined based on past soil dryness as well as the current soil dryness, and suitable growth advice can be given. Even in an environment where the temperature is low and plants are resting, the plants should be watered if the environment is constantly being controlled by air-conditioning. In the present invention, advice to water a plant can be given even in such an environment.

Note that, although the plant growth database 6 is included on the server device 5 side in the above-described first embodiment, the present invention is not limited thereto, and the plant growth database 6 may be provided on the mobile phone 1 side. As a result of the plant growth database 6 being provided on the mobile phone 1 side, the mobile phone 1 can acquire season-specific growth basic information without the server device 5. Also, the plant growth database 6 is not necessarily required to be included in the mobile phone 1, and may be externally provided via a recording medium such as a secure digital (SD) card.

### Second Embodiment

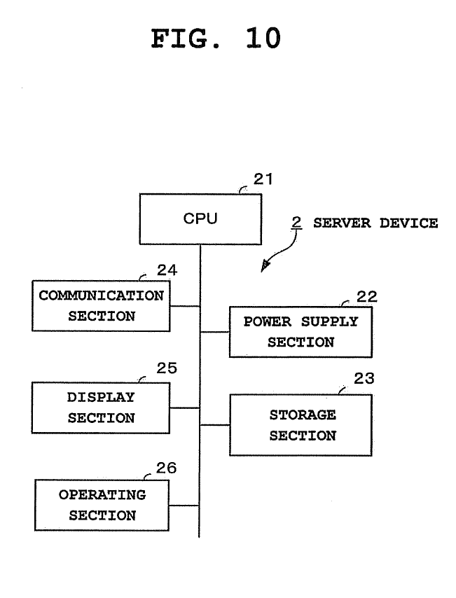

A second embodiment of the present invention will hereinafter be described with reference to FIG. 10 to FIG. 12.

In the above-described first embodiment, a season is determined and the relevant growth information (growth advice) is specified as an output object on the mobile phone 1 side. However, in the second embodiment, a season is determined and the relevant growth information (growth advice) is specified as an output object on the server device 5 side. Note that sections that are basically the same in both embodiments and sections having the same name in both embodiments are given the same reference numerals, and descriptions thereof are omitted. Further, note that in the descriptions below, the characteristic portion of the second embodiment will mainly be described.

FIG. 10 is a block diagram showing basic components of the server device 5 according to the second embodiment.

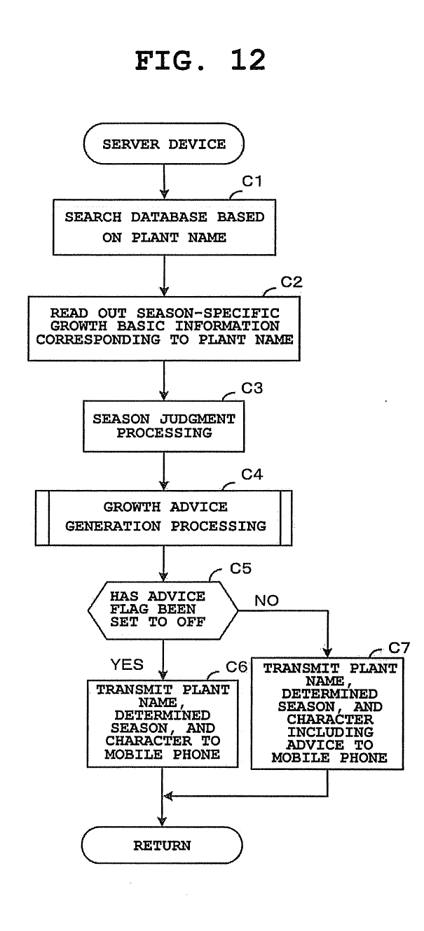

A CPU 21 shown therein is a section that operates by receiving power from a power supply section 22, and controls the overall operation of the server device 5 based on various programs stored in a storage section 23. The storage section 23 stores programs for actualizing the second embodiment based on operation procedures shown in FIG. 12, various applications, and the like. A communication section 24, a display section 25, and an operating section 26 are connected to the CPU 21 as peripheral devices. The server device 5 according to the second embodiment receives and acquires environments of a plant detected by the sensor device 2, via the mobile phone 1, the wireless communication network 3, and the Internet 4, and acquires season-specific growth basic information for the plant by searching the plant growth database 6. Then, it judges whether the current environment of the plant is equivalent to a specific season for the plant, based on the environments detected by the sensor device 2 and the season-specific growth basic information acquired from the plant growth database 6, and after growth information relevant to the determined season is specified as an output object, transmits this growth information to the mobile phone 1.

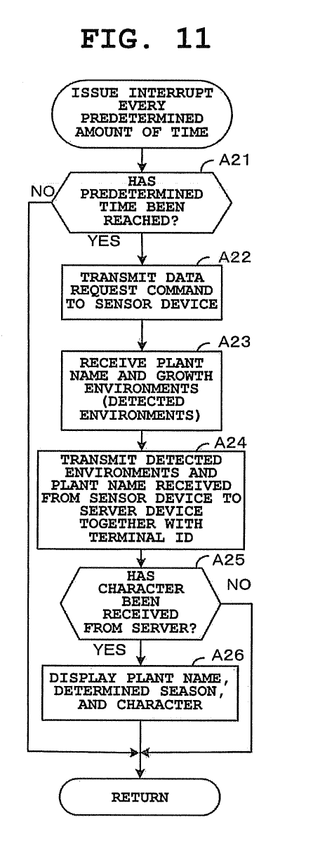

FIG. 11 is a flowchart outlining operations of the characteristic portion of the second embodiment from among all of the operations of the mobile phone 1, which are started by an interrupt that is issued every predetermined amount of time (such as one minute), as in the case of FIG. 6. Note that, after exiting the flow in FIG. 11, the procedure returns to the main flow (not shown) of the overall operation.

First, the CPU 11 judges whether or not a predetermined time (such as 8 am) set in advance has been reached, or in other words, whether or not request timing for issuing a request to the sensor device 2 has been reached (Step A21). When judged that the request timing has not yet been reached (NO at Step A21), the CPU 11 exits the flow in FIG. 11. When judged that the request timing has been reached (YES at Step A21), the CPU 11 transmits a request command requesting data transmission and its own terminal identification (ID) to the sensor device 2 (Step A22). Then, when the growth environments (detected environments) of a plant are received from the sensor device 2 side (Step A23), the mobile phone 1 transmits the received environments and its own terminal ID to the server device 5 (Step A24), and waits for a response from the server device 5 (Step A25).

FIG. 12 is a flowchart outlining operations performed on the server device 5 side in the second embodiment, which are started every time data is received from the mobile phone 1.

First, when the plant name, the detected environments, and the terminal ID are received from the mobile phone 1, the server device 5 searches the plant growth database 6 based on the received plant name (Step C1), and reads out season-specific growth basic information relevant to the plant (Step C2). Subsequently, the server device 5 performs season judgment processing similar to that of the above-described first embodiment based on the detected environments received from the sensor device 2 via the mobile phone 1 and the season-specific growth basic information read out from the plant growth database 6 (Step C3).

Then, after performing the season judgment processing, the server device 5 proceeds to Step C4 and performs growth advice generation processing (Step C4). The growth advice generation processing is performed according to the flow in FIG. 7 and FIG. 8, as in the case of the first embodiment. When the growth advice processing is completed, the server device 5 judges whether or not the advice flag has been set to “OFF” (Step C5). When judged that the advice flag has been set to “OFF” (YES at Step C5), the server device 5 transmits, for example, the plant name, the determined season, and a character expressing the plant such as that shown in FIG. 9A to the mobile phone 1, as a character to which growth information (growth advice) has not been added (Step C6). When judged that the advice flag is set has been “ON”(NO at Step C5), the server device 5 transmits, for example, the plant name, the determined season, and a character including growth advice such as those shown in FIG. 9B and FIG. 9C to the mobile phone 1, as a character to which growth information (growth advice) has been added (Step C7).

When this character is received from the server device 5 (YES at Step S25 in FIG. 11), the mobile phone 1 displays it on the display section 16 (terminal screen) (Step A26). In this instance, when the character does not include growth advice, a terminal screen such as that shown in FIG. 9A is displayed. When the character does include growth advice, a terminal screen such as those shown in FIG. 9B and FIG. 9C is displayed.

As described above, the server device 5 according to the second embodiment judges whether the current environment of a plant is equivalent to a specific season for the plant, based on the environment of the plant detected by the sensor device 2 and season-specific growth basic information acquired from the plant growth database 6. Subsequently, the growth information applicable to the judged season is specified as an output object, and transmitted to the mobile phone 1. Therefore, the mobile phone 1 is only required to transfer environments detected by the sensor device 2 to the server device 5. Since the season judgment processing and the growth advice generation processing are performed on the server device 5 side, the processing load on the mobile phone 1 is significantly reduced. In the second embodiment as well, when outputting growth information for a plant based on a correlation between the type of the plant and a season, the growth information can be changed according to the growth environment of the plant irrespective of a calendar, as in the case of the first embodiment. Accordingly, even when plants are being grown indoors, plant growing that is suitable to the indoor environment is possible, and as a result the plants are adequately grown while being protected from abnormal weather and the like.

Note that, although a season is determined based on air temperature in the above-described embodiments, it may be determined taking into consideration humidity and the like, in addition to air temperature. Further, although information recommending watering has been given as an example of growth information (growth advice) based on a season in the above-described embodiments, information recommending fertilization or tending may be outputted depending on the season. Moreover, the display is not limited to character display, and other expressive drawings, such as icons, may be displayed.

In addition, advice in the above-described embodiments may be given to a user using sensory or experiential methods through a combination of the camera function and augmented reality (AR) technology. That is, a configuration may be adopted in which, when a growing plant is captured by the imaging section 15, the growth environments of the plant are received and acquired from the sensor device 2 near the plant, the above-described season judgment processing and growth advice generation processing are performed, and a character including growth advice is displayed within the captured image. In this instance, a configuration may be applied in which a plant, which is incapable of self-expression, is humanized and personified through an anthropomorphic advice presentation by an AR character. As a result, the emotional value of virtually experiencing the feelings of a plant through the character and the realistic value of reducing the difficulty of plant management and cultivation can be provided to the user.

Moreover, although in the above-described embodiments the growth subjects are plants, the present invention is not limited thereto. The growth subjects may be fish, birds such as parakeets and Java sparrows, dogs, cats, etc. In these cases, a pet environment or a fish tank environment in the rearing room of a store or the like may be measured, and the sensor device 2 may be provided in a collar for dogs, cats and the like, or inside a fish tank.

Furthermore, in the above-described embodiments, the present invention has been applied to a mobile phone, as an information terminal device. However, the present invention may be applied to a personal digital assistant (PDA), a digital camera, a music player, a personal computer (PC), etc.

Still further, the “devices” or the “sections” described in the above-described embodiments are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An information terminal device comprising:
a receiving section which receives a detected environment detected from a sensor device equipped with an environment sensor that detects a growth environment of a growth subject with the environment sensor;
an acquisition section which acquires season-specific growth basic information according to a type of the growth subject, when the detected environment is received;
a judgment section which judges whether the current environment of the growth subject is equivalent to a season specifically for the growth subject, based on the detected environment and the season-specific growth basic information;
a specification section which specifies growth information applicable to the season as an output object; and
an output control section which outputs information representing the season that corresponds with the growth information to an output section, when the growth information is specified as an output object.

2. The information terminal device according to claim 2, wherein the output control section displays a drawing expressing a growth method of the growth subject as the growth information, and a seasonal drawing as information expressing a season.

3. The information terminal device according to claim 1, wherein the growth subject is a plant,
wherein the receiving section receives a plurality of detected environments related to air temperature as time-series changes in air temperature from the sensor device that sequentially stores a plurality of environments periodically detected by a temperature sensor for detecting air temperature around the plant, and
wherein the judgment section determines a highest temperature or a lowest temperature from the changes in air temperature, and judges whether the current environment of the growth subject is equivalent to a season specifically for the growth subject, based on the lowest temperature or the highest temperature and the season-specific growth basic information related to air temperature acquired in the acquisition section.

4. The information terminal device according to claim 3, wherein the receiving section further receives a plurality of detected environments as a soil dryness condition in time-series from the sensor device that sequentially stores the plurality of detected environments periodically detected by a moisture sensor for detecting the soil dryness condition of a plant being grown; and
wherein the specification section specifies information related to watering that corresponds to the growth information as an output object, based on the season and the received soil dryness condition.

5. A growth management system comprising:
a sensor device;
an information terminal device; and
a server device,
wherein the sensor device comprises an environment sensor which detects a growth environment of a growth subject and a first transmitting section which transmits a detected environment,
wherein the information terminal device comprises a first receiving section which receives the detected environment and a second transmitting section which transmits the detected environment to the server device, and
wherein the server device comprises:
a second receiving section which receives the detected environment from the information terminal device;
a third transmitting section;
an acquisition section which acquires season-specific growth basic information according to a type of the growth subject, when the detected environment is received;
a judgment section which judges whether the current environment of the growth subject is equivalent to a season specifically for the growth subject, based on the detected environment and the season-specific growth basic information;
a specification section which specifies growth information applicable to the season as an output object; and
a transmission control section which controls the third transmitting section to transmit the growth information to the information terminal device.

6. A non-transitory computer-readable storage medium having stored thereon a program that is executable by a computer, the program being executable by the computer to perform functions comprising:
processing for outputting growth information based on a correlation between a type of a growth subject and a season;
processing for receiving a detected environment detected from a sensor device equipped with an environment sensor that detects a growth environment of the growth subject with the environment sensor;
processing for acquiring season-specific growth basic information according to the type of the growth subject, when the detected environment is received;
processing for judging whether the current environment of the growth subject is equivalent to a season specifically for the growth subject, based on the detected environment and the season-specific growth basic information;
processing for specifying the growth information applicable to the season as an output object; and
processing for outputting information representing the season that corresponds with the growth information, when the growth information is specified as an output object.

7. A non-transitory computer-readable storage medium having stored thereon a program that is executable by a computer, the program being executable by the computer to perform functions comprising:
processing for receiving a detected environment via a network from an information terminal device which acquires the detected environment detected from a sensor device equipped with an environment sensor that detects a growth environment of a growth subject with the environment sensor;
processing for acquiring season-specific growth basic information according to a type of the growth subject, when the detected environment is received;
processing for judging whether the current environment of the growth subject is equivalent to a season specifically for the growth subject, based on the detected environment and the season-specific growth basic information;
processing for specifying growth information applicable to the season as an output object, and
processing for transmitting the growth information to the information terminal device.
